(19) United States
(12) Patent Application Publication
(10) Pub. No.: US 2008/0222672 A1
(43) Pub. Date: Sep. 11, 2008

(54) Monitoring of a Broadcast Signal

(75) Inventor: Jonathan R. Piesing, Croydon (GB)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/569,172

(22) PCT Filed: Aug. 26, 2004
(86) PCT No.: PCT/IB04/02796

§ 371 Date: Feb. 22, 2006

(30) Foreign Application Priority Data
Sep. 3, 2003 (GB) 0320618.2

(51) Int. Cl. H04N 7/025; H04N 7/08

(52) U.S. Cl. 725/20; 725/137

(57) ABSTRACT

A method of monitoring a broadcast signal (28) comprises receiving a broadcast signal (28), the broadcast signal including a timebase (23), monitoring the broadcast signal (28) for an identification signal (24), and pausing the timebase (23) if the identification signal (24) is not present. The method further comprises restarting the timebase (23), once the identification signal (24) is present.

This invention relates to a method of and apparatus for monitoring a broadcast signal.

In traditional analogue broadcast television, video and audio signals are broadcast over a wide area for receipt by any suitable device within range. Data, in the form of teletext, can also be sent in the analogue system, the teletext being effectively hidden within the video signal in a defined manner. The receiving apparatus in an analogue system strips out the teletext from the signal, which is then available for access by the user, via the user interface of the television they are using. This allows the broadcast of simple text pages.

In the more recent innovation of digital television, the broadcast system is designed so that the transmitting apparatus broadcasts three different components. These components are the video, audio and data components of the signal. By having a defined data component with a defined available bandwidth, far superior functionality can be achieved than with the legacy teletext systems. In a digital system, as well as being able to send text to a receiving device, interactive applications can also be sent that are run by the receiving device. These interactive applications can be in the form of text and graphics based information about the programme being broadcast, but can also be more complicated applications that include interaction with the television viewer. A typical example would be the ability to play along with a quiz show, so that the user is presented with the same questions as the studio competitors and can select, via their remote control, answers to the questions.

In a typical digital television system, such as defined, for example, by DVB (Digital Video Broadcasting, the standard for digital broadcasting used in Europe) the digital encoding scheme used is MPEG-2, which includes within it several mechanisms to encode one or more timebases into the encoded signal. In one such mechanism, each timebase is inserted into the signal at a minimum of once every second and the receiving apparatus need only check the value of the timebase once every 5 seconds. For example, in the case of a quiz show, the broadcaster will wish to include a timebase that starts from the beginning of the programme at time zero and continues through the programme until it finishes. The purpose of the timebase, amongst other things, is to allow correct control of the interactive application that is associated with the television programme. In one implementation, the broadcaster will include within the interactive application the times at which the relevant menus are to be displayed on the screen, and the receiving apparatus synchronises the interactive application with the broadcast video and audio by reading the timebase contained within the signal. In an alternative implementation, the broadcaster will include in the encoded signal, a set of events, each event containing the time at which that event is to be reported to the interactive application by the receiving apparatus. The receiving apparatus reads the timebase contained within the signal and then reports the event to the interactive application when the broadcast timebase matches the time contained in the event.

However a number of problems with this system can occur, mostly due to the insertion of material further down the broadcasting chain. In particular, the insertion of advertisements by a distributor is in many instances carried out without any reference to the original programme. The distributor does not know what is contained in the interactive application; they simply break the audio, video and data streams and insert the new material, being the advertisement. The timebase in the original signal will also be interrupted and this creates a potential problem because many receivers are not complex enough to handle the interruption, they either do not respond quick enough, or they have a defined period in which they wait for the timebase to restore, assuming that the interruption is an error (as of course the broadcast signal can be affected by atmospherics and temporary reflections). This leads to problems in the synchronisation of the interactive application.

It is therefore an object of the invention to provide an improvement of the known systems and apparatus.

According to a first aspect of the present invention, there is provided a method of monitoring a broadcast signal, comprising receiving a broadcast signal, the broadcast signal including a timebase, monitoring the broadcast signal for an identification signal, and pausing the timebase if the identification signal is not present.

According to a second aspect of the present invention, there is provided apparatus for monitoring a broadcast signal, comprising receiving means for receiving the broadcast signal, the broadcast signal including a timebase, and monitoring means for monitoring the broadcast signal for an identification signal, and for pausing the timebase if the identification signal is not present.

Owing to the invention, it is possible to provide apparatus for receiving a signal that is able to identify the absence of the timebase immediately, and accordingly pause the timebase. This ensures that any actions by the receiving device that are dependent on the timebase are not executed inadvertently.

In a preferred system, the broadcast signal comprises a video component, an audio component, and a data component, and the timebase is a portion of the data component of the broadcast signal. In a digital system, the broadcast signal is a digital signal and the identification signal is present in the data component of the broadcast signal. In an analogue system, the broadcast signal is an analogue signal and the identification signal is present in the vertical blanking interval of the broadcast signal.

Preferably, the identification signal is present in the normal data structures describing the video component of the broadcast signal.

Advantageously, the receiving apparatus is a digital television receiver and the receiving means and the monitoring means are portions of an integrated circuit. The monitoring means is arranged to restart the timebase, once the identification signal is present. This ensures that the video and audio streams of the broadcast are resynchronised with the interactive application.

Embodiments of the invention will now be described, by way of example only, with reference to the accompanying drawing in which:

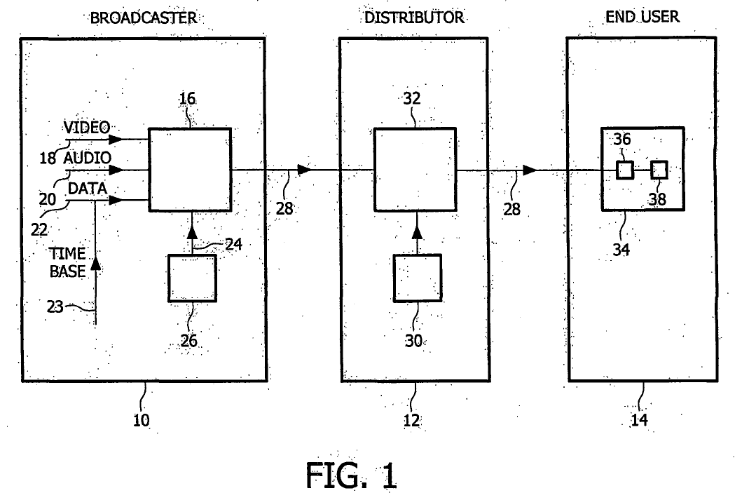

FIG. 1 is a schematic diagram of a system for the generating, broadcast and receipt of a broadcast signal,

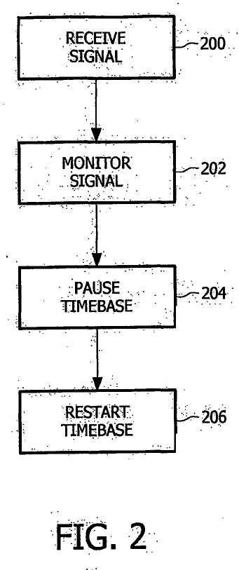

FIG. 2 is a flow diagram of a method of monitoring a broadcast signal,

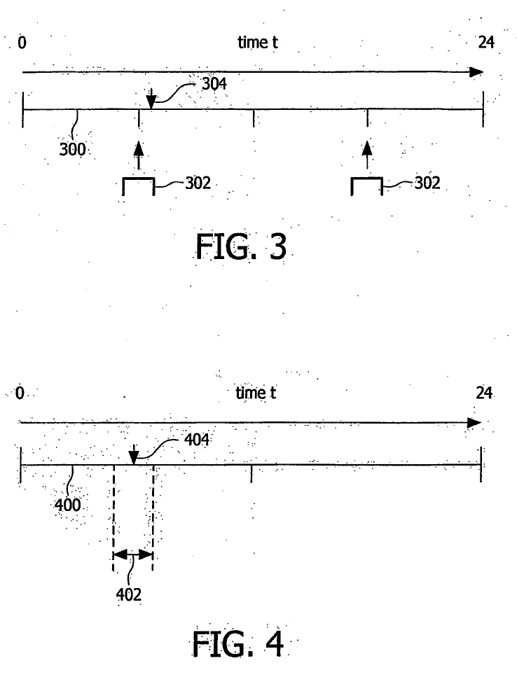

FIG. 3 is a schematic diagram of a broadcast signal, and

FIG. 4 is a schematic diagram of a second broadcast signal.

In FIG. 1, the actions of the broadcaster, distributor and end user are shown respectively at 10, 12 and 14. Only one distributor 12 is illustrated, but in many situations there will be other distributors and/or network operators in the distribution chain.

In this embodiment, the originator of the broadcast signal is provided with a multiplexer 16. This multiplexes a video component 18, an audio component 20 and a data component 22 with an identification signal 24 produced by a device 26, to generate a broadcast signal 28. The data component 22 will in most instances contain an interactive application. Included in the data component 22 is a timebase 23, which is a periodic clock inserted into the data component 22 every second.

The interactive application typically relates to the material being broadcast. For example, if the broadcast material is a golf tournament then the interactive application may contain statistical information on the golfers participating, a hole-by-hole map of the course, or an interactive leaderboard. The end user 14 can access these functions as desired through a suitable user interface. In the system of FIG. 1, the interactive application that is transmitted to the end user 14 is part of the data component that is a portion of the broadcast signal 28.

The device 26 produces an identification signal 24 at a regular interval in the form of a “heartbeat” that is carried in the video/audio distribution channel of the signal 28. This identification signal 24 is synchronised with the signal 28.

The broadcast signal 28 is transmitted to the distributor 12 who is free to break up this signal 28 as desired, by the addition of further broadcast material. In most cases this extra material is retrieved from a database 30 that contains commercials (and potentially interactive applications associated with those commercials) that are spliced into the signal 28 by an insertion device 32. This now-modified signal 28 comprises the original broadcast signal with the video, audio and data components 18, 20 and 22, and an identification signal 24, broken up by commercials, that do not have any corresponding identification signal 24, nor the timebase 23.

The signal 28 is broadcast to the end user's receiver 34, which in this embodiment is a digital television receiver in the form of a set top box. The receiver 34 is arranged to display on its associated display device (not shown), usually an analogue television, the broadcast video component and output the broadcast audio component of the channel selected by the user 14. The user 14 can access the interactive application, as desired, from a suitable remote control device. In most cases, the interactive application is shown on the display device superimposed upon the video component of the broadcast, with the user 14 able to make selections to navigate the interactive application.

The receiver 34, which comprises apparatus for monitoring the broadcast signal 28, comprises receiving means 36 for receiving the broadcast signal 28, the broadcast signal 28 including the timebase 23, and monitoring means 38 for monitoring the broadcast signal 28 for an identification signal 24, and for pausing the timebase 23 if the identification signal 24 is not present.

Therefore in those sections of the broadcast signal 28 that have been added by the distributor 12 and do not have an identification signal, the monitoring means 38 will note the absence of the identification signal 24 and pause the timebase 23. The monitoring means 38 is, however, arranged to restart the timebase 23, once the identification signal 24 is present. This is discussed in more detail below with reference to FIGS. 3 and 4.

The receiving means 36 and monitoring means 38 as shown in FIG. 1 are discrete components within the receiver 34, but they could alternatively be formed as portions of an integrated circuit. Equally the operations of these functional elements of the receiver 34 could be achieved by computer program elements of the software controlling the receiver 34.

Typically the “heartbeat” of the identification signal 24 occurs as a periodic pulse in the signal 28 and the monitoring of the identification signal allows a time delay of, for example, twice the frequency of the pulse before pausing the timebase. The identification signal 24 has a period of half a second, although any suitable short period of time is acceptable. The identification signal 24 would likely be placed somewhere the receiver 34 would already be monitoring as part of its normal operation to minimise requirements for extra complexity in the receiver.

The embodiment of FIG. 1 relates to a digital broadcast signal 28, but in an alternative embodiment the broadcast signal is an analogue signal and the identification signal is present in the vertical blanking interval (VBI) of the broadcast signal. In analogue television, the “heartbeat” signal can be carried in one of the television lines in the VBI normally used for carrying teletext data. In a more specific example, if the interactive applications are using the ATVEF (Advanced Television Enhancement Forum) technology, this would rely on the carriage of multicast IP in those VBI lines and the “heartbeat” would take the form of a UDP packet sent on a dedicated multicast IP address.

FIG. 2 summarises the steps involved in the method of monitoring the broadcast signal 28. The method comprises receiving 200 the broadcast signal 28, the broadcast signal 28 including a timebase 23, monitoring 202 the broadcast signal 28 for an identification signal 24, and pausing 204 the timebase 23 if the identification signal 24 is not present. The method further comprises restarting 208 the timebase 23, once the identification signal 24 is present.

As described above, the broadcast signal 28 comprises a video component 18, an audio component 20, and a data component 22 and the timebase 23 is a portion of the data component 22 of the broadcast signal 28. The flow chart of the method, illustrated in FIG. 2 covers both possibilities of the broadcast system, the first being where the broadcast signal 28 is a digital signal and the identification signal 24 is present in the data component 22 of the broadcast signal 28, and the second being where the broadcast signal 28 is an analogue signal and the identification signal 24 is present in the vertical blanking interval of the broadcast signal.

FIGS. 3 and 4 illustrate examples of broadcast signals. In FIG. 3, the broadcast signal is in the form of a programme shown as the line 300 extending over a time 0 to a time 24, being a programme twenty-four minutes in length. This programme 300 is created by the broadcaster 10 or by a third party who is in close cooperation with the broadcaster 10. The programme 300 comprises video, audio and data signals. In this example, the programme 300 is a quiz show, and the data portion of the signal contains an interactive application that allows the final end user to play along with the quiz show. The interactive application contains menus corresponding to the questions put to the contestants and also has the functionality to score the users inputs and generate a final score for the user.

The various aspects of the interactive application need to be time controlled to a relatively high degree of accuracy. The menus need to appear on the end user's screen at the right moment in the programme 300, and (more fundamentally) the user must be prevented from inputting an answer to the interactive application after the correct answer has been given in the actual programme 300. Alternatively it may be the case that the user is given the same amount of time to answer any question as the actual contestant. All of the time dependent aspects of the interactive application need to be controlled with reference to the timebase of the programme 300.

One such time dependent incident is illustrated by the arrow 304. This incident 304 is occurring at shortly after the six-minute mark and represents the user being prevented from answering a question. In practical terms, the programme 300 is pre-recorded by the creator and the interactive application is added afterwards with careful synchronisation between the programme 300, the timebase and the interactive application.

However in this example, the programme 300 is passing through a distributor 12 who is reselling the programme 300. This is a regular occurrence in the television business, particular when programmes that originate in one country are shown for the first time in another country. The distributor 12 wishes to add their own advertisements (shown in FIG. 3 as the units marked 302) to the programme 300 and the six minute and eighteen minute marks in the programme 300. The distributor 12 does not have any idea about the content of the interactive application, nor any timings within it. As a result, the distributor 300 is adding an advertisement 302, very close to the executing of an action 304 by the interactive application associated with this programme 300.

In many conventional receivers, this will lead to a malfunctioning of the interactive application. Although the original timebase 23 will not be present during the period of the advertisement 302, the receiver will for a short period continue running the timebase 23, on the basis that the timebase 23 is “lost” from the original signal rather than it intentionally not being present. The conventional receiver will therefore execute the event 304 during the advertisement 302, because the interactive application is controlled to execute that event 304 from the timebase (which is still running). The user will return to. the programme after the advertisement, ready to input their answer to the quiz question, only to find that they are already prevented from answering the question, this being the role of the event 304.

In the case of the receiver 34, however, this set of circumstances is handled in such a way as not to cause any failure in the running of the interactive application. The monitoring means 38 is monitoring the signal for the presence of the identification signal 24. As soon as this signal 24 is not present, as would be the case when the distributor 12 has inserted the advertisement 302, the timebase 23 is paused by the receiver 34. This would mean that the interactive application would not execute the event 304, because it has not yet reached the appropriate point in the timebase 23 to execute the event.

When the identification signal 24 is restored, the monitoring means 38 is arranged to restart the timebase 23, once the identification signal 24 is present. Therefore when the advertisement 302 is finished, and the original programme 300 is being received by the receiver 34, the timebase 23 is restarted and the interactive application will execute its events in proper synchronisation with the video and audio streams of the programme 300.

FIG. 4 shows a second situation that will not be handled correctly by the prior art receivers, but will be handled properly by the receiver 34. In this instance the programme 400 is being redistributed by a distributor 12 on a local basis. In many countries of the world television channels that are broadcast throughout the entirety of a country are in fact regionalised to an extent. A local distributor has the power to interrupt the “national” broadcast as they see fit. This is not a trivial example, for example, in some regions of the USA, extreme weather warnings are broadcast several times a year, and take the form of an interruption of the broadcast by a local rebroadcaster. In the Figure, numeral 402 is used to indicate the section of the original programme 400 that is to be interrupted with the extreme weather warning. As before, in the example described with reference to FIG. 3, in the original programme 400 there is an interactive application that has an event to be executed at the point 404.

In a conventional receiver with its timebase still running despite the interruption by the distributor at 402, the event 404 will still be executed. If this event (as will be the case in many examples) is the presentation of a menu on the screen, this will have disastrous consequences, as the extreme weather warning will be obscured by the on screen menu of the interactive application!

In the case of the receiver 34, however, this set of circumstances is handled in such a way as not to execute any interactive application events. The monitoring means 38 is monitoring the signal for the presence of the identification signal 24. As soon as this signal 24 is not present, as would be the case when the distributor 12 has interrupted the broadcast with the warning 402, the timebase 23 is paused by the receiver 34. This would mean that the interactive application would not execute the event 404, because it has not yet reached the appropriate point in the timebase 23 to execute the event.

In this way the use of the identification signal 24 by the receiver 34 to control the timebase 23 results in an improved handling of complicated situations involving unplanned interruptions in original broadcast signal 28.

1. A method of monitoring a broadcast signal (28), comprising receiving (200) a broadcast signal (28), the broadcast signal (28) including a timebase (23), monitoring (202) the broadcast signal (28) for an identification signal (24), and pausing (204) the timebase (23) if the identification signal (24) is not present.

2. A method according to claim 1, wherein the broadcast signal (28) comprises a video component (18), an audio component (20), and a data component (22).

3. A method according to claim 2, wherein the timebase (23) is a portion of the data component (22) of the broadcast signal (28).

4. A method according to claim 2 or 3, wherein the broadcast signal (28) is a digital signal (28) and the identification signal (24) is present in the data component (22) of the broadcast signal (28).

5. A method according to claim 1, 2 or 3, wherein the broadcast signal is an analogue signal and the identification signal is present in the vertical blanking interval of the broadcast signal.

6. A method according to any preceding claim, and further comprising restarting (206) the timebase (23), once the identification signal (24) is present.

7. A method according to any preceding claim, wherein the identification signal (24) is present in the normal data structures describing the video component (22) of the broadcast signal (28).

8. Apparatus for monitoring a broadcast signal (28), comprising receiving means (36) for receiving the broadcast signal (28), the broadcast signal (28) including a timebase (23), and monitoring means (38) for monitoring the broadcast signal (28) for an identification signal (24), and for pausing the timebase (23) if the identification signal (24) is not present.

9. Apparatus according to claim 8, wherein the signal (28) comprises a video component (18), an audio component (20), and a data component (22).

10. Apparatus according to claim 8 or 9, wherein the timebase (23) is a portion of the data component (22) of the broadcast signal (28).

11. Apparatus according to claim 8, 9 or 10, wherein the receiving means (36) and the monitoring means (38) are portions of an integrated circuit.

12. Apparatus according to any one of claims 8 to 11, wherein the apparatus is a digital television receiver (34).

13. Apparatus according to any one of claims 8 to 12, wherein the monitoring means (38) is arranged to restart the timebase (23), once the identification signal (24) is present.
